(19) United States
(12) Patent Application Publication
(10) Pub. No.: US 2024/0308377 A1
(43) Pub. Date: Sep. 19, 2024

(54) CONTROL DEVICE FOR POWER SUPPLY DURING TRAVEL

(71) Applicant: TOYOTA JIDOSHA ABUSHIKI KAISHA, Toyota-shi (JP)

(72) Inventors: Naohiro SEO, Sunto-gun (JP); Toshiya HASHIMOTO, Miyoshi-shi (JP); Masato MAEMURA, Numazu-shi (JP); Ryosuke IKEMURA, Susono-shi (JP); Shogo TSUGE, Sunto-gun (JP)

(73) Assignee: TOYOTA JIDOSHA ABUSHIKI KAISHA, Toyota-shi (JP)

(21) Appl. No.: 18/410,107

(22) Filed: Jan. 11, 2024

(30) Foreign Application Priority Data
Mar. 17, 2023 (JP) 2023-043320

(51) Int. Cl. B60L 53/62; B60L 53/122; B60L 53/30; B60L 53/36; B60L 53/38; B60L 53/66; B60L 53/68

(52) U.S. Cl. CPC B60L 53/62; B60L 53/122; B60L 53/32; B60L 53/36; B60L 53/38; B60L 53/66; B60L 53/68

(57) ABSTRACT

The control device for power supply during travel includes a processor, and the processor sets the power supply lane to the power reception lane in the case of power shortage, and sets the power supply lane to the power transmission lane in the case of power surplus, according to the supply and demand balance of the power system, and outputs information to guide surrounding vehicles to the power receiving lane or power transmission lane.

### CROSS-REFERENCE TO RELATED APPLICATION

This application claims priority to Japanese Patent Application No. 2023-043320 filed on Mar. 17, 2023, incorporated herein by reference in its entirety.

### BACKGROUND

### 1. Technical Field

The present disclosure relates to a control device for power supply during travel.

### 2. Description of Related Art

Japanese Unexamined Patent Application Publication No. 2011-244532 (JP 2011-244532 A) describes a power supply system including two power supply lanes, power supply equipment provided along each power supply lane, and a control device that outputs to a vehicle an instruction on which power supply lane the vehicle should travel in depending on the remaining capacity of a battery of the vehicle.

### SUMMARY

Since it is conceivable to provide power supply lanes with the function of receiving electric power from the vehicle side, a scheme is required that handles the supply-demand balance of the entire energy management.

The present disclosure has been made in view of the above, and an object of the present disclosure is to provide a control device for power supply during travel that can handle the supply-demand balance of an electric power system.

The present disclosure provides a control device for power supply during travel, the control device including
a processor, in which
the processor is configured to:
set a power supply lane as a power reception lane in case of a power shortage, and set the power supply lane as a power transmission lane in case of a power surplus, depending on a supply-demand balance of a power system; and
output information for guiding surrounding vehicles to the power reception lane or the power transmission lane.

The present disclosure provides a control device for power supply during travel, the control device including
a processor, in which
the processor is configured to:
set one of a plurality of power supply lanes provided on a road as a power reception lane and set another one of the power supply lanes as a power transmission lane; and
adjust power of a vehicle traveling in the power reception lane and power of a vehicle traveling in the power transmission lane.

According to the present disclosure, it is possible to handle the supply-demand balance of an electric power system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an overview of a wireless power transmission system to which a control device for power supply during travel according to an embodiment is applied;

FIG. 2 is a diagram showing an overview of first control executed by the control device for power supply during travel according to the embodiment;

FIG. 3 is a diagram illustrating an overview of second control executed by the control device for power supply during travel according to the embodiment;

FIG. 4 is a flowchart showing a first control flow executed by the control device for power supply during travel according to the embodiment; and

FIG. 5 is a flowchart showing a second control flow executed by the control device for power supply during travel according to the embodiment.

### DETAILED DESCRIPTION OF EMBODIMENTS

A control device for power supply during travel according to an embodiment of the present disclosure will be described with reference to the drawings. Components in the following embodiments include components that can be easily replaced by those skilled in the art, or components that are substantially the same.

### Wireless Power Transfer System

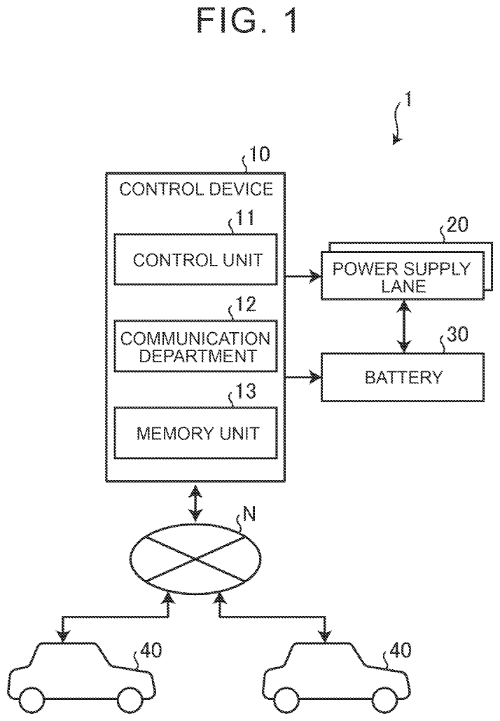

A Wireless Power Transfer System to which a control device for power supply during travel (hereinafter also simply referred to as a “control device”) according to an embodiment is applied will be described with reference to FIGS. 1 to 3.

The wireless power transmission system 1 performs wireless power transmission from the power supply lane 20 to the vehicle 40 by, for example, magnetic field resonance coupling. As shown in FIG. 1, the wireless power transmission system 1 includes a control device 10, a power supply lane 20, a battery 30, and a vehicle 40.

Both the control device 10 and the vehicle 40 have a communication function and are configured to be able to communicate with each other through the network N. This network N includes, for example, an Internet line network, a mobile phone line network, Wireless Fidelity (WiFi; registered trademark), Bluetooth (registered trademark), Low Energy (BLE), and the like.

The control device 10 exchanges various information with the vehicle 40 and controls the power supply lane 20 and the battery 30. The control device 10 includes a control unit 11, a communication unit 12, and a storage unit 13.

Specifically, the control unit 11 includes a processor including a Central Processing Unit (CPU), a Digital Signal Processor (DSP), a Field-Programmable Gate Array (FPGA), a Graphics Processing Unit (GPU), etc., and a Random Access Memory (RAM), Read Only Memory (ROM), etc. (main memory).

The control unit 11 loads the program stored in the storage unit 13 into the work area of the main storage unit and executes it, and controls each component etc. through the execution of the program, thereby achieving functions that meet a predetermined purpose. The control unit 11 specifically performs first control and second control. Each control will be explained below.

### First Control

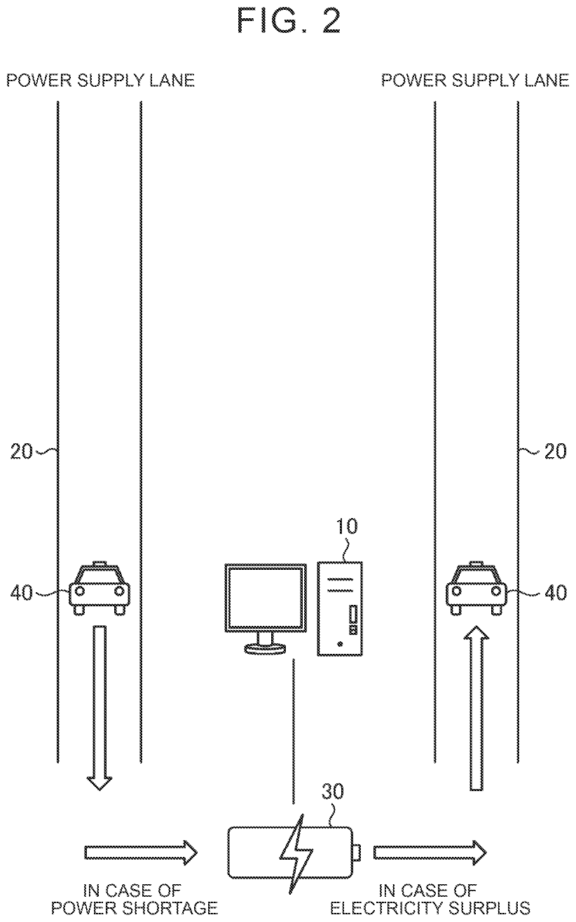

The control unit 11 sets the power supply lane 20 as a power receiving lane in accordance with the supply and demand balance of the power system, for example, when the power system is in a power shortage (for example, during a disaster), and sets the power supply lane 20 as a power transmission lane when the power system has a surplus of power. That is, as shown in FIG. 2, when there is a shortage of power in the power system, the control unit 11 causes the power supply lane 20 to function as a power receiving lane, receives power from the vehicle 40, and stores the power in the battery 30.

Further, when there is surplus power in the power system, the control unit 11 causes the power supply lane 20 to function as a power transmission lane, and supplies power from the battery 30 to the vehicle 40. Note that the “power system” includes, for example, the battery 30 and vehicle 40 that constitute the wireless power transmission system 1, external power generation equipment, external consumer equipment, and the like.

Furthermore, when the power supply lane 20 is set as a power reception lane or a power transmission lane, the control unit 11 provides information (guidance information) for guiding the vehicle 40 traveling around the power supply lane 20 to the power reception lane or the power transmission lane. This guidance information is information including, for example, the position of the power reception lane or the power transmission lane, the distance to the power reception lane or the power transmission lane, and the like. The vehicle 40 that has acquired the guidance information notifies the user (for example, the driver) of the guidance information through, for example, the display or speaker of the navigation device.

Further, the control unit 11 may output information for guiding the vehicle 40 traveling around the power supply lane 20 to the power receiving lane when the power system is short of power. Thereby, the vehicle 40 that supplies power to the infrastructure side can be guided to the power receiving lane preferentially. Further, the control unit 11 may output information for guiding the vehicle 40 traveling around the power supply lane 20 to the power transmission lane when there is a power surplus in the power system. Thereby, vehicles 40 that wish to receive power supply from the infrastructure side can be guided to the power transmission lane preferentially.

Further, the control unit 11 may output information regarding the availability of the power reception lane or the availability of the power transmission lane to the vehicle 40 traveling around the power supply lane 20. Thereby, the user of the vehicle 40 can grasp the availability status of the power receiving lane or the power transmission lane.

### Second Control

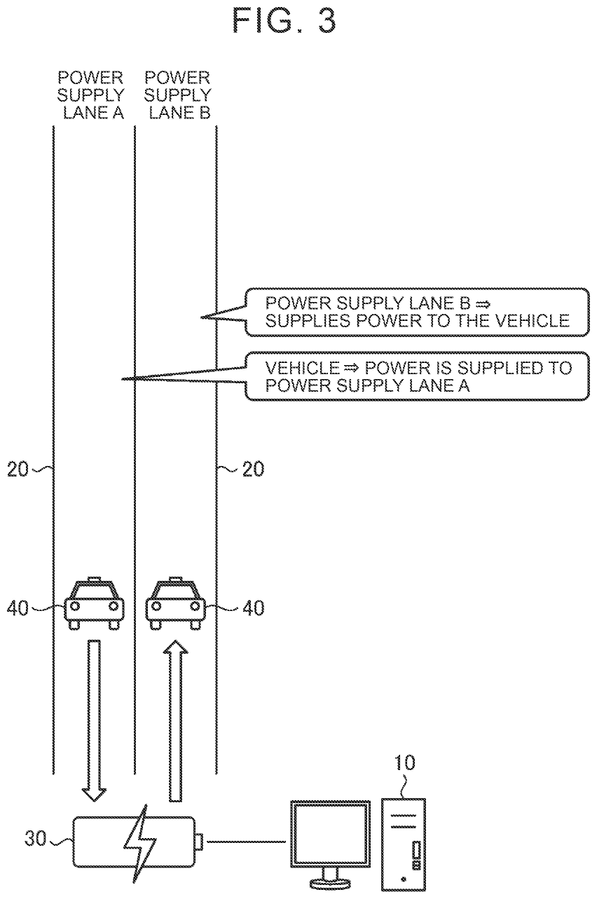

The control unit 11 sets one of the plurality of power supply lanes 20 provided along the road as a power receiving lane, and sets the other as a power transmission lane. Thereby, the control unit 11 adjusts the power of the vehicle 40 traveling on the power receiving lane and the power of the vehicle 40 traveling on the power transmission lane. That is, as shown in FIG. 3, electric power is supplied from a vehicle 40 traveling on a power receiving lane (power supply lane A in the figure) and stored in the battery 30.

Furthermore, power is supplied from the battery 30 to the vehicle 40 traveling on the power transmission lane (power supply lane B in FIG. 3). Although the figure assumes that two power supply lanes 20 are provided on the road, for example, only one power supply lane 20 may be provided on the road. In this case, a part of the power supply lane 20 may be set as a power reception lane, and the remaining part may be set as a power transmission lane, and the same control as above may be performed.

In addition, when the power supply lane 20 is set as a power reception lane or a power transmission lane, the control unit 11 outputs information (guidance information) for guiding the vehicle 40 traveling around the power supply lane 20 to the power reception lane or the power transmission lane. This guidance information is information including the position of the power reception lane or power transmission lane, the distance to the power reception lane or the power transmission lane, and the like. The vehicle 40 that has acquired the guidance information notifies the user (for example, the driver) of the guidance information through, for example, the display or speaker of the navigation device.

Further, the control unit 11 may output information for guiding the vehicle 40 traveling around the power supply lane 20 to the power receiving lane when the power system is short of power. Thereby, the vehicle 40 that supplies power to the infrastructure side can be guided to the power receiving lane preferentially. Further, the control unit 11 may output information for guiding the vehicle 40 traveling around the power supply lane 20 to the power transmission lane when there is a power surplus in the power system. Thereby, vehicles 40 that wish to receive power supply from the infrastructure side can be guided to the power transmission lane preferentially.

Further, the control unit 11 may output information regarding the availability of the power reception lane or the availability of the power transmission lane to the vehicle 40 traveling around the power supply lane 20. Thereby, the user of the vehicle 40 can grasp the availability status of the power receiving lane or the power transmission lane.

The communication unit 12 includes, for example, a communication module that can transmit and receive various information. For example, when power is supplied to the vehicle 40 from the power supply lane 20 (power transmission lane) or when the power supply lane 20 (power reception lane) receives power from the vehicle 40, the communication unit 12 communicates with the vehicle through the network N, for example. It communicates with 40 and sends and receives various information.

The storage unit 13 includes a recording medium such as an erasable programmable ROM (EPROM), a hard disk drive (HDD), and a removable medium. Examples of removable media include disc recording media such as Universal Serial Bus (USB) memory, Compact Disc (CD), Digital Versatile Disc (DVD), and Blu-ray (registered trademark) Disc (BD). The storage unit 13 can store an operating system (OS), various programs, various tables, various databases, and the like.

The storage unit 13 stores, for example, various information exchanged with the vehicle 40, power transmission lane/power reception lane setting information of the power supply lane 20, information regarding the remaining capacity of the battery 30, and the like.

The power supply lane 20 is configured to be able to supply power to the vehicle 40 in a contactless manner and to receive power from the vehicle 40 in a contactless manner. Specifically, the power supply lane 20 includes a power transmitting device including a coil that supplies power to the vehicle 40 and a power receiving device including a coil that receives power from the vehicle 40. These coils are also embedded within road lanes.

Battery 30 is a stationary power storage device. This battery 30 supplies power to the power supply lane 20 when the power supply lane 20 functions as a power transmission lane. Furthermore, when the power supply lane 20 functions as a power receiving lane, the battery 30 receives power from the power supply lane 20 and stores the power. Further, the battery 30 may receive power from an external power generation facility, or may supply power to external consumer equipment. Note that although only one battery 30 is illustrated in FIG. 1, one battery 30 may be provided for each power supply lane 20.

The vehicle 40 is an electrified vehicle that can be charged with electric power supplied from an external power source, such as a battery electric vehicle (BEV) or a plug-in hybrid electric vehicle (PHEV). This vehicle 40 may be a manually driven vehicle or an automatically driven vehicle. The vehicle 40 also includes a communication unit (for example, a Data Communication Module (DCM)) for communicating with the control device 10.

How to Control Power Supply while Driving

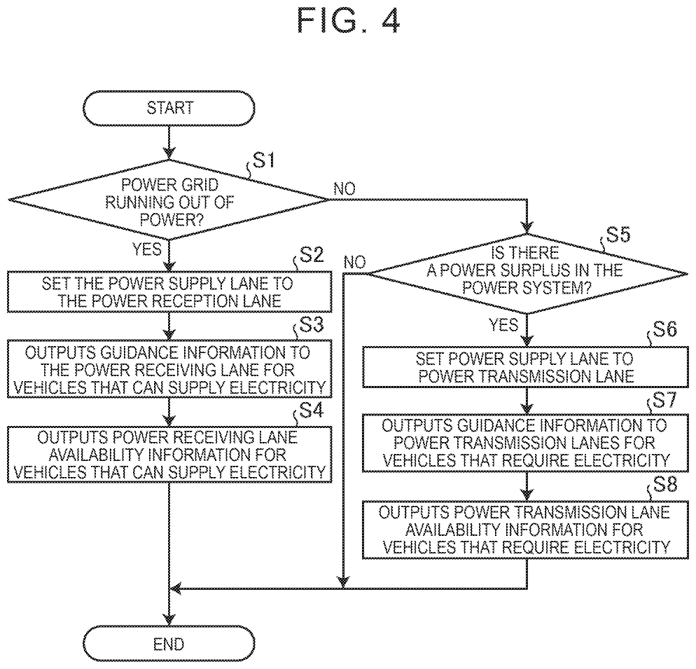

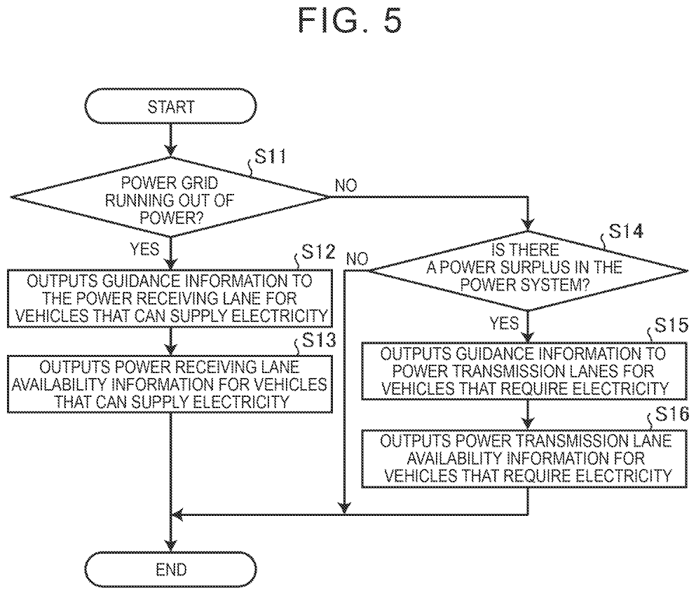

A method of controlling power supply while running executed by the control device for power supply during travel according to the embodiment will be described with reference to FIGS. 4 and 5. FIG. 4 shows the first control flow. Moreover, FIG. 5 shows the flow of the second control. The flow of each control will be explained below.

### First Control

First, the control unit 11 determines whether there is a power shortage in the power grid (S1). If it is determined in S1 that the power system is short of power (Yes in S1), the control unit 11 sets the power supply lane 20 as the power receiving lane (S2).

Subsequently, the control unit 11 outputs guidance information to the power receiving lane to the vehicle 40 capable of supplying power (S3). Subsequently, the control unit 11 outputs power reception lane availability information to the vehicle 40 capable of supplying power (S4), and completes this process.

Here, if it is determined in S1 that the power grid is not in a power shortage (No in S1), it is determined whether the power grid is in surplus power (S5). If it is determined in S5 that the power system has surplus power (Yes in S5), the control unit 11 sets the power supply lane 20 as a power transmission lane (S6).

Subsequently, the control unit 11 outputs guidance information to the power transmission lane to the vehicle 40 that requires power (S7). Subsequently, the control unit 11 outputs power transmission lane availability information to the vehicle 40 that requires power (S8), and completes this process. Note that if it is determined in S5 that the power system does not have surplus power (No in S5), the control unit 11 completes this process. In the first control, by performing the above-described control, it is possible to cope with the power supply and demand balance.

### Second Control

First, the control unit 11 determines whether there is a power shortage in the power grid (S11). If it is determined in S11 that the power system is short of power (Yes in S11), the control unit 11 outputs guidance information to the power receiving lane to the vehicle 40 that can be supplied with power (S12). Subsequently, the control unit 11 outputs power reception lane availability information to the vehicle 40 capable of supplying power (S13), and completes this process.

Here, if it is determined in S11 that the power system is not in a power shortage (No in S11), it is determined whether the power system has a power surplus (S14). If it is determined in S14 that the power system has surplus power (Yes in S14), the control unit 11 outputs guidance information to the power transmission lane to the vehicle 40 that requires power (S15). Subsequently, the control unit 11 outputs power transmission lane availability information to the vehicle 40 that requires power (S16), and completes this process. Note that if it is determined in S14 that the power system does not have surplus power (No in S14), the control unit 11 completes this process. In the second control, the power supply and demand balance among the plurality of power supply lanes 20 can be adjusted by performing the above control.

According to the control device for power supply during travel according to the embodiment described above, it is possible to cope with the supply and demand balance of the electric power system.

Further advantages and modifications can be easily derived by those skilled in the art. Therefore, the broader aspects of the disclosure are not limited to the specific details and representative embodiments shown and described above. Accordingly, various changes may be made without departing from the spirit or scope of the general inventive concept defined by the appended claims and equivalents thereof.

What is claimed is:

1. A control device for power supply during travel, the control device comprising
a processor, wherein the processor is configured to:
set a power supply lane as a power reception lane in case of a power shortage, and set the power supply lane as a power transmission lane in case of a power surplus, depending on a supply-demand balance of a power system; and
output information for guiding surrounding vehicles to the power reception lane or the power transmission lane.

2. The control device according to claim 1, wherein the processor is configured to:
output information for guiding the vehicle to the power reception lane in case of a power shortage; and
output information for guiding the vehicle to the power transmission lane in case of a power surplus.

3. The control device according to claim 1, wherein the processor is configured to output information about an availability status of the power reception lane or an availability status of the power transmission lane to the vehicle.

4. A control device for power supply during travel, the control device comprising
a processor, wherein the processor is configured to:
set one of a plurality of power supply lanes provided on a road as a power reception lane and set another one of the power supply lanes as a power transmission lane; and
adjust power of a vehicle traveling in the power reception lane and power of a vehicle traveling in the power transmission lane.

5. The control device according to claim 4, wherein the processor is configured to:
output information for guiding the vehicle to the power reception lane in case of a power shortage; and
output information for guiding the vehicle to the power transmission lane in case of a power surplus.

6. The control device according to claim 4, wherein the processor is configured to output information about an availability status of the power reception lane or an availability status of the power transmission lane to the vehicle.
